(19) United States
(12) Patent Application Publication
(10) Pub. No.: US 2012/0021214 A1
(43) Pub. Date: Jan. 26, 2012

(54) FUNCTIONAL FILM AND LAMINATE

(76) Inventors: Takeshi Hasegawa, Saitama (JP); Satoshi Negishi, Saitama (JP); Susumu Kurishima, Saitama (JP)

(21) Appl. No.: 13/260,350

(22) PCT Filed: Mar. 9, 2010
(86) PCT No.: PCT/JP2010/053891

§ 371 Date: Sep. 25, 2011

(30) Foreign Application Priority Data
Mar. 31, 2009 (JP) 2009-084615

(51) Int. Cl. B32B 27/00; C09J 7/02; B32B 7/12

(52) U.S. Cl. 428/346; 428/411.1

(57) ABSTRACT

A functional film that does not show decrease of surface hardness even when an adhesive layer for adhering it to another member is provided, and does not generate separation nor delamination at the time of die cutting, and a laminate thereof are provided. The functional film can include a plastic film having a functional layer constituted by a cured film on one surface and an adhesive layer on the other surface. The adhesive layer contains a curable adhesive that can be cured by irradiation of ionizing radiation or heating, and is constituted so that the adhesive layer after cured by irradiation of ionizing radiation or heating shows a Martens hardness of 260 N/mm² or lower, and the following relational expression is satisfied. Martens hardness of the adhesive layer after curing≧Martens hardness of the functional layer×0.25

This application is a U.S. national phase filing under 35 U.S.C. §371 of PCT Application. No. PCT/JP2010/053891, filed Mar. 9, 2010, and claims priority under 35 U.S.C. §119 to Japanese patent application. no. 2009-084615, filed Mar. 31, 2009, the entireties of both of which are incorporated herein by reference.

### TECHNICAL FIELD

The presently disclosed subject matter relates to a functional film and a laminate, in particular, a functional film that minimizes reduction of the surface hardness of a laminate formed by adhering the functional film to a surface of an adherend via an adhesive layer, and such a laminate.

### BACKGROUND ART

In order to improve surface hardness of a member, a cured layer is provided on a surface of the member. Such a cured layer can be provided on a surface of a member by applying a coating solution for cured layer or the like (Patent document 1), or by adhering a film on which a cured layer is formed via an adhesive layer (Patent document 2).

### CONVENTIONAL ART REFERENCES

### Patent Documents

Patent document 1: Japanese Patent Unexamined Publication (Kokai) No. 2009-35703 (Prior Art)
Patent document 2: Japanese Patent Unexamined Publication No. 2008-50590 (Claim 6)

### SUMMARY

However, when a cured layer is directly provided on a surface of a member by applying a coating solution for cured layer to the member and curing it, adhesive property of the cured layer to the surface of the member may pose a problem. Since adhesion is usually influenced by type of material, structure and so forth of the surface of the member, it can be difficult to design a coating solution applicable to any members. Therefore, in general, in order to improve adhesion between a member and a cured layer, an adhesion promoting layer and so forth should or must be also provided in this arrangement.

The method of Patent document 2 for providing a cured layer on a surface of a member by adhering a film on which a cured layer is formed via an adhesive layer is advantageous, since it is a simpler method compared with directly providing a coated film on a member as described above, and a cured layer can be thereby provided on a surface of a member regardless of material, structure and so forth of the member.

However, surface hardness of such a member adhered with a film on which a cured layer is formed is influenced by hardness of the adhesive layer. In particular, when a soft adhesive layer is used, there arises a problem that surface hardness of the member adhered with a film on which a cured layer is formed becomes lower than the surface hardness of the cured layer itself.

Therefore, an aspect of the presently disclosed subject matter is to provide a functional film of which surface hardness reduction is minimized or not reduced even when an adhesive layer for adhering it to another member is provided, and a laminate thereof.

As a result of various researches for achieving the aforementioned aspect, it was found that if an adhesion layer before curing was designed so that surface hardness of a functional layer constituted by a cured film and surface hardness of the adhesive layer after curing satisfy a particular relationship, reduction of the surface hardness of the functional layer could be minimized or prevented.

In addition, it was also found that when a film on which a cured layer was formed was adhered to a surface of a member via a hard adhesive layer, and then the adhered member is cut into a predetermined shape by die cutting, separation or delamination between the film and the adhesion layer could be prevented at the time of die cutting, and the presently disclosed subject matter was accomplished.

That is, the functional film of the presently disclosed subject matter can be a functional film including a plastic film having a functional layer constituted by a cured film on one surface and an adhesive layer on the other surface, wherein:

the adhesive layer contains a curable adhesive that can be cured by irradiation of ionizing radiation or heating, and

the adhesive layer is constituted so that the adhesive layer after cured by irradiation of ionizing radiation or heating shows a Martens hardness of 260 N/mm² or lower, and the relational expression: Martens hardness of the adhesive layer after curing≧Martens hardness of the functional layer×0.25 is satisfied.

The laminate of the presently disclosed subject matter is a laminate including a plastic film having a functional layer constituted by a cured film on one surface and an adherend adhered to the plastic film via an adhesive layer, wherein:

the adhesive layer contains a curable adhesive that can be cured by irradiation of ionizing radiation or heating, and

the adhesive layer is constituted so that the adhesive layer after cured by irradiation of ionizing radiation or heating shows a Martens hardness of 260 N/mm² or lower, and the relational expression: Martens hardness of the adhesive layer after curing≧Martens hardness of the functional layer×0.25 is satisfied.

Here, “Martens hardness of the functional layer” means “Martens hardness of the functional layer before adhered to the adherend via the adhesive layer”.

The laminate of the presently disclosed subject matter is also a laminate formed by adhering an adherend to a plastic film having a functional layer constituted by a cured film on one surface via an adhesive layer, and then curing the adhesive layer, wherein:

the adhesive layer contains a curable adhesive that can be cured by irradiation of ionizing radiation or heating, and

the adhesive layer is constituted so that the adhesive layer after cured by irradiation of ionizing radiation or heating shows a Martens hardness of 260 N/mm₂ or lower, and the relational expression: Martens hardness of the adhesive layer after curing≧Martens hardness of the functional layer×0.25 is satisfied.

Here, “Martens hardness of the functional layer” means “Martens hardness of the functional layer before adhered to the adherend via the adhesive layer”.

Concerning the functional film and the laminate of the presently disclosed subject matter, the simple indication of “adhesive layer” is used to mean the adhesive layer “before completion of curing”, which means the adhesive layer before completion of the curing reaction. The state “before completion of curing” includes a state “before start of curing”, which means a state before start of the curing reaction (for example, a state that 100% of the curable components of the curable adhesive exist in the adhesive layer), and a state “after start of curing”, which means a state after start of the curing reaction and before completion of the curing reaction (for example, a state that less than 100% and not less than about 5% of the curable components of the curable adhesive exist in the adhesive layer). However, a state “after completion of curing”, which means a state after completion of the curing reaction (for example, a state that only less than about 5% of the curable components of the curable adhesive exist in the adhesive layer) is excluded.

In the presently disclosed subject matter, the term “after curing” is used to mean “after start of curing” and “after completion of curing” mentioned above, and the meaning thereof is not limited to the meaning of “after completion of curing” mentioned above. The term is used with such meanings, because the film is not necessarily subjected to die cutting process immediately after the start of curing, and there is taken into consideration a case where the film is subjected to the process after a certain period of time (for example, about 1 to 3 days after irradiation or heating). In addition, the term “before curing” is used to mean “before start of curing” mentioned above.

The functional film of the presently disclosed subject matter can prevent reduction of surface hardness thereof, when it is adhered to an adherend. Moreover, when it is subjected to die cutting, it does not show either separation or delamination.

In the laminate of the presently disclosed subject matter, reduction of surface hardness of the functional film can be prevented. Moreover, when it is subjected to die cutting, it does not show either separation or delamination.

### DETAILED DESCRIPTION OF EXEMPLARY EMBODIMENTS

Embodiments of the functional film of the presently disclosed subject matter will be explained.

The functional film of the presently disclosed subject matter can be a functional film including a plastic film having a functional layer constituted by a cured film on one surface and an adhesive layer on the other surface, wherein:

the adhesive layer contains a curable adhesive that can be cured by irradiation of ionizing radiation or heating, and

the adhesive layer is constituted so that the adhesive layer after cured by irradiation of ionizing radiation or heating shows a Martens hardness of 260 N/mm² or lower, and the relational expression: Martens hardness of the adhesive layer after curing≧Martens hardness of the functional layer×0.25 is satisfied.

As the plastic film, films that can include or that can consist of a synthetic resin such as polyester, ABS (acrylonitrile/butadiene/styrene), polystyrene, polycarbonate, acrylic resin, polyolefin, cellulose resin, polysulfone, polyphenylene sulfide, polyethersulfone, polyetheretherketone, and polyimide can be used. In an exemplary embodiment, a polyester film subjected to stretching, especially biaxial stretching, can provide superior mechanical strength, superior dimensional stability, and high bending strength thereof.

On one surface of the plastic film, the functional layer is provided. The functional layer used in the presently disclosed subject matter can be a layer that can include or that can consist of a cured layer formed by curing a resin composition containing a curable resin. As the curable resin, a thermosetting resin or an ionizing radiation curable resin can be used. In an exemplary embodiment, an ionizing radiation curable resin can be used to obtain higher surface hardness.

Further, the functional layer may have functions of hard coat layer, UV shielding layer, infrared shielding layer, conductive layer, anti-reflection layer, and so forth. In order to impart such functions, various pigments and additives can be added, and it is also possible to use a curable resin having such a function.

On the other side of the plastic film, the adhesive layer is provided. The adhesive layer used in the presently disclosed subject matter contains a curable adhesive that can be cured by irradiation of ionizing radiation or heating.

An exemplary curable adhesive that can be cured by irradiation of ionizing radiation, can be or can consist of at least a coating material that can cure through crosslinking induced by irradiation of ionizing radiation. Exemplary ionizing radiation curable coating materials can include but are not limited to photo cation polymerizable resins that can be polymerized by photo cation polymerization, those formed by mixing one or two or more kinds of photopolymerizable prepolymers or photopolymerizable monomers that can be polymerized by photo radical polymerization. Further, various additives can be added to such ionizing radiation curing coating materials, and when ultraviolet radiation is used for the curing additives such as, but not limited to, a photopolymerization initiator, an ultraviolet radiation sensitizing agent can be used.

An exemplary curable adhesive that can be cured by heating can include a thermosetting resin that can cure through crosslinking induced by heat at a temperature lower than the heat-resistant temperature of the plastic film, since a coating solution containing the thermosetting resin is applied on the plastic film, and cured by crosslinking induced by heating, and one kind or a mixture of two or more kinds of crosslinkable resins that can cure through crosslinking induced by heating such as those of, but not limited to, melamine type, epoxy type, amino alkyd type, urethane type, acrylic type, polyester type and phenol type. An exemplary embodiment using acrylic type thermosetting resins can improve the surface hardness, and show good adhesive property for the plastic film. Although they can be independently used, it is possible to add a curing agent in order to further improve crosslinking property and hardness of coated film cured through crosslinking.

The curing reaction of such curable adhesives can be started by irradiation of ionizing radiation or heating. In an exemplary embodiment when a curable adhesive that can be cured by irradiation of ionizing radiation is used, it can be adhered to an adherend before the curing reaction is started, and then cured. If it is adhered before the curing, the adhesive layer can be prevented from becoming harder to entrap bubbles at the time of adhesion. When a curable adhesive that can be cured by heating is used, it may be adhered to an adherend before the curing reaction is started, and then cured, as in the case where a curable adhesive that can be cured by irradiation of ionizing radiation is used, but it may also be adhered to an adherend after the curing reaction is started by heating and before the curing reaction is completed, and then the remaining part of the curing reaction may be allowed to advance.

As the curing agent, compounds such as, but not limited to, polyisocyanates, amino resins, epoxy resins and carboxylic acids can be appropriately chosen according to compatibility with the resins and used.

The adhesive layer used in the presently disclosed subject matter can be constituted by choosing a curable adhesive of which composition of resins, monomers, oligomers etc. is determined so that, first, Martens hardness of the adhesive layer after curing satisfies, together with Martens hardness of the functional layer, the relational expression: Martens hardness of the adhesive layer after curing≧Martens hardness of the functional layer×0.25. The term “after curing” is not used here to mean that the aforementioned relationship must be necessarily satisfied in all or most of the states observed after start of curing or after completion of curing, but means that it is sufficient that the aforementioned relationship is satisfied at least after completion of curing. Therefore, not only a case where the aforementioned relationship is not satisfied from start of curing to immediately before completion of curing, but it is satisfied after curing, but also a case where the aforementioned relationship is satisfied in all or most of the states observed after start of curing or after completion of curing corresponds to the definition used in the presently disclosed subject matter that the adhesive layer “after curing” satisfies the aforementioned relationship.

In the presently disclosed subject matter, the composition of the adhesive layer before curing can be adjusted so that Martens hardness of the adhesive layer after curing corresponds to 25% or more in one embodiment, or 30% or more in another embodiment, of Martens hardness of the functional layer. If the composition of the adhesive layer before curing is adjusted so that Martens hardness of the adhesive layer after curing corresponds to 25% or more of the Martens hardness of the functional layer, it is possible to prevent reduction of the surface hardness of the functional layer.

The Martens hardness represents the hardness (difficulty of denting) of the adhesive layer, which is calculated from a test load and dented area observed when the surface of the adhesive layer is pushed with a Vickers indenting tool, and serves as an index of the hardness of the adhesive layer.

The adhesive layer used in the presently disclosed subject matter can be constituted by a curable adhesive of which composition of resins, monomers, oligomers etc. is adjusted so that, second, Martens hardness of the adhesive layer after curing is 260 N/mm2 or lower. The term “after curing” is not used here to mean that the Martens hardness of the adhesive layer must necessarily be the aforementioned value or lower in all or most of the states observed after start of curing or after completion of curing, but means that it is sufficient that the Martens hardness of the adhesive layer is the aforementioned value or smaller at least during a period of from start of curing to immediately before completion of curing. Therefore, not only a case where the Martens hardness of the adhesive layer is not the aforementioned value or smaller after completion of curing, but the Martens hardness of the adhesive layer is the aforementioned value or lower during a period of from start of curing to immediately before completion of curing, but also a case where in all or most of the states observed after start of curing or after completion of curing, the Martens hardness of the adhesive layer is the aforementioned value or lower corresponds to the definition of the presently disclosed subject matter that the Martens hardness of the adhesive layer “after curing” shows a Martens hardness of the aforementioned value or lower.

In the presently disclosed subject matter, the Martens hardness of the adhesive layer after curing is represented with values measured by the method defined in ISO-14577-1 with a super-microhardness tester (trade name: Fischer Scope HM2000, Fischer Instruments Corporation) in an atmosphere of a temperature of 20° C. and a relative humidity of 60%.

In the presently disclosed subject matter, the curable adhesive is constituted so that the adhesive layer after curing shows a Martens hardness of 260 N/mm² or lower in one embodiment, and 200 N/mm² or lower in another embodiment. If the curable adhesive is constituted so that the adhesive layer after curing shows a Martens hardness of 260 N/mm² or lower, generation of separation or delamination at the time of die cutting can be prevented.

It is considered that if the curable adhesive is constituted so that the adhesive layer after curing shows a Martens hardness of 260 N/mm² or lower, generation of separation or delamination between the plastic film and the adhesive layer can be prevented at the time of die cutting as described above, because if the Martens hardness is higher than 260 N/mm², a strong force might be required to cut the plastic film with a blade, thus repelling force of the plastic film becomes unduly large, and therefore separation or delamination is generated between the plastic film and the adhesive layer.

If the Martens hardness is unduly high, the laminate may be curled by shrinkage of the curable adhesive at the time of curing, or partial unevenness is generated in a film or molded article on which the cured layer was formed to degrade flatness. Therefore, in an exemplary embodiment, the Martens hardness is not unduly high.

The Martens hardness of the adhesive layer after curing can be controlled by adjusting composition of the monomers and oligomers constituting the resin used for the adhesive layer before curing, or composition of the resin used for the adhesive layer before curing. Further, it can also be controlled by adding a thermoplastic resin, besides the curable adhesive. In order to increase the Martens hardness of the adhesive layer after curing, for example, crosslinking density of the adhesive layer after curing may be increased, or monomer components used for dilution may be changed to those of which homopolymer shows a higher glass transition temperature. In order to increase the crosslinking density, tetra- to hexa-functional monomers giving high crosslinking density (for example, A-DPH (Shin Nakamura Chemical Co., Ltd.) and A-TMMT (Shin Nakamura Chemical Co., Ltd.)) or the like may be added. In order to elevate the glass transition temperature, acrylic acid, acrylamide, or the like may be added.

In an exemplary embodiment, thickness of the adhesive layer can be 1 to 50 μm. As for the lower limit of the thickness, in one embodiment of the adhesive layer the thickness can be 2 μm or larger, in another embodiment, the thickness can be 5 μm or larger, or in yet another embodiment, the thickness can be 10 μm or larger, and as for the upper limit of the thickness, in one embodiment, the adhesive layer can have a thickness of 40 μm or smaller, or in another embodiment, the thickness can be 30 μm or smaller. The thickness is defined to be 1 μm or larger in order to obtain satisfactory adhesive property with an adherend, and 50 μm or smaller in order to lessen influence of hardness of the adhesive layer on the functional layer. Further, as the thickness of the adhesive layer becomes larger, exposure dose of the ionizing radiation on the plastic film increases, and thus the plastic film may be deteriorated. An exemplary exposure dose of the ionizing radiation can be 500 to 1500 mJ/cm².

Such a functional film as described above is adhered to an adherend via an adhesive layer, and can prevent decrease of the surface hardness of the functional layer of the laminate.

Hereafter, embodiments of the laminate of the presently disclosed subject matter will be explained.

The laminate of the presently disclosed subject matter can be a laminate including a plastic film having a functional layer constituted by a cured film on one surface and an adherend adhered to the plastic film via an adhesive layer, wherein the adhesive layer contains a curable adhesive that can be cured by irradiation of ionizing radiation or heating, and the adhesive layer is constituted so that the adhesive layer after cured by irradiation of ionizing radiation or heating shows a Martens hardness of 260 N/mm² or lower, and the relational expression: Martens hardness of the adhesive layer after curing≧Martens hardness of the functional layer×0.25 is satisfied.

Further, the laminate of the presently disclosed subject matter also can be a laminate formed by adhering an adherend to a plastic film having a functional layer constituted by a cured film on one surface via an adhesive layer, and then curing the adhesive layer, wherein the adhesive layer contains a curable adhesive that can be cured by irradiation of ionizing radiation or heating, and the adhesive layer is constituted so that the adhesive layer after cured by irradiation of ionizing radiation or heating shows a Martens hardness of 260 N/mm² or lower, and the relational expression: Martens hardness of the adhesive layer after curing≧Martens hardness of the functional layer×0.25 is satisfied.

As the adherend on which such a functional layer is laminated, exemplary molded articles can include or can consist of a synthetic resin such as polyester, ABS (acrylonitrile/butadiene/styrene), polystyrene, polycarbonate, acrylic resin, polyolefin, cellulose resin, polysulfone, polyphenylene sulfide, polyethersulfone, polyetheretherketone, and polyimide can be used, and those of various shapes can be used. In an exemplary embodiment, those in the form of a film or sheet showing superior flatness can be used, and in another exemplary embodiment, a polyester film subjected to stretching, especially biaxial stretching, can be used, because of superior mechanical strength, superior dimensional stability, and high bending strength thereof.

As the plastic film having a functional layer, those similar to the aforementioned functional film can be used. Further, as the adhesive layer, those explained for the aforementioned functional film can be used.

The adhesive layer may be provided on the plastic film having a functional layer on the side not having the functional layer, or may be directly provided on an adherend on which the plastic film having a functional layer is to be provided. Further, the adhesive layer may be provided by filling a material of the adhesive layer between the plastic film having a functional layer and the adherend.

In such a laminate formed by laminating the plastic film having a functional layer on an adherend via an adhesive layer, hardness of the functional layer of the laminate is not influenced by the adhesive layer, and decrease thereof can be prevented.

The adhesive layer or the functional layer may contain additives such as, but not limited to, leveling agents, ultraviolet absorbers and anti-oxidants.

Examples of the method for forming the adhesive layer or the functional layer can include a method of preparing a coating solution by dissolving or dispersing components of each layer in an appropriate solvent, or mixing the components of each layer without using any solvent, applying the coating solution on the plastic film by a method such as roll coating, bar coating, spray coating and air knife coating, and performing heating or irradiation of ionizing radiation. It is also possible to cast the prepared solution, not to use it as a coating solution, to form the adhesive layer.

### EXAMPLES

Hereafter, the presently disclosed subject matter will be further explained with reference to examples. The term and symbol “part” and “%” are used on weight basis, unless specifically indicated.

### Example 1

On one surface of a plastic film having a thickness of 75 μm (COSMOSHINE A4300, Toyobo Co., Ltd.), the following hard coat coating material was applied by bar coating, dried, and then irradiated with ultraviolet radiation by using a high pressure mercury vapor lamp (exposure dose: 300 mJ/cm²) to form a hard coat film of Example 1 having a thickness of 6 μm and thereby produce a plastic film a having a hard coat layer.

### <Composition of Hard Coat Coating Material>

| | | |
|---|---|---|
| Ionizing radiation curable resin composition | 10 | parts |
| (solid content: 100%, Beamset 575, | | |
| Arakawa Chemical Industries, Ltd.) | | |
| Photopolymerization initiator | 0.5 | part |
| (Irgacure 651, Ciba Japan K.K.) | | |
| Propylene glycol monomethyl ether | 23 | parts |

On the surface of the plastic film a having the hard coat layer on the side opposite to the hard coat layer side, a coating material for adhesive layer having the following composition was applied in a thickness of 30 μm, and dried to form an adhesive layer (before curing). Then, a plastic film having a thickness of 188 μm (COSMOSHINE A4300, Toyobo Co., Ltd.) as an adherend was faced and adhered to the adhesive layer, and they were irradiated with ultraviolet radiation by using a high pressure mercury vapor lamp (exposure dose: 500 mJ/cm²) to completely cure the adhesive layer (adhesive layer “after completion of curing”, the same shall apply to the following descriptions) and thereby produce a laminate A of Example 1.

### <Composition of Coating Material for Adhesive Layer>

| | |
|---|---|
| Ionizing radiation curable resin | 60 parts |
| (solid content: 100%, KAYARAD R-115, | |
| Nippon Kayaku Co., Ltd.) | |
| 2-Hydroxyethyl methacrylate | 40 parts |
| Photopolymerization initiator | 5 parts |
| (Irgacure 184, Ciba Japan K.K.) | |

### Example 2

A laminate B of Example 2 was produced in the same manner as that of Example 1 except that the coating material for adhesive layer of Example 1 was changed to the following coating material for adhesive layer.

### <Composition of Coating Material for Adhesive Layer>

| | |
|---|---|
| Ionizing radiation curable resin | 20 parts |
| (solid content: 100%, KAYARAD R-115, | |
| Nippon Kayaku Co., Ltd.) | |
| Ionizing radiation curable resin | 40 parts |
| (solid content: 100%, NK Oligo U-200PA, | |
| Shin-Nakamura Chemical Co., Ltd.) | |
| 2-Hydroxyethyl methacrylate | 40 parts |
| Photopolymerization initiator | 5 parts |
| (Irgacure 184, Ciba Japan K.K.) | |

### Example 3

On one surface of a plastic film having a thickness of 75 μm (COSMOSHINE A4300, Toyobo Co., Ltd.), the following hard coat coating material was applied by bar coating, dried, and then irradiated with ultraviolet radiation by using a high pressure mercury vapor lamp (exposure dose: 300 mJ/cm²) to form a hard coat film of Example 3 having a thickness of 3 μm and thereby produce a plastic film b having a hard coat layer.

### <Composition of Hard Coat Coating Material>

| | | |
|---|---|---|
| ε-Caprolactone-modified tris- | 5 | parts |
| (2-hydroxyethyl)isocyanurate | | |
| (solid content: 100%, SR368, | | |
| Sartomer Japan Inc.) | | |
| Ionizing radiation curable resin composition | 10 | parts |
| (solid content: 100%, Beamset 575, | | |
| Arakawa Chemical Industries, Ltd.) | | |
| Photopolymerization initiator | 0.4 | part |
| (Irgacure 651, Ciba Japan K.K.) | | |
| Propylene glycol monomethyl ether | 30 | parts |

On the surface of the plastic film b having the hard coat layer on the side opposite to the hard coat layer side, a coating material for adhesive layer having the following composition was applied in a thickness of 30 μm, and dried to form an adhesive layer (before curing). Then, a plastic film having a thickness of 188 μm (COSMOSHINE A4300, Toyobo Co., Ltd.) as an adherend was faced and adhered to the adhesive layer, and they were irradiated with ultraviolet radiation by using a high pressure mercury vapor lamp (exposure dose: 500 mJ/cm²) to completely cure the adhesive layer and thereby produce a laminate C of Example 3.

### <Composition of Coating Material for Adhesive Layer>

| | |
|---|---|
| Ionizing radiation curable resin | 60 parts |
| (solid content: 100%, KAYARAD R-115, | |
| Nippon Kayaku Co., Ltd.) | |
| 2-Hydroxyethyl methacrylate | 40 parts |
| Photopolymerization initiator | 5 parts |
| (Irgacure 184, Ciba Japan K.K.) | |

### Example 4

A laminate D of Example 4 was produced in the same manner as that of Example 3 except that the coating material for adhesive layer of Example 3 was changed to the following coating material for adhesive layer.

### <Composition of Coating Material for Adhesive Layer>

| | |
|---|---|
| Ionizing radiation curable resin | 30 parts |
| (solid content: 100%, KAYARAD R-115, | |
| Nippon Kayaku Co., Ltd.) | |
| Ionizing radiation curable resin | 30 parts |
| (solid content: 100%, NK Oligo U-200PA, | |
| Shin-Nakamura Chemical Co., Ltd.) | |
| 2-Hydroxyethyl methacrylate | 40 parts |
| Photopolymerization initiator | 5 parts |
| (Irgacure 184, Ciba Japan K.K.) | |

### Comparative Example 1

A laminate E of Comparative Example 1 was produced in the same manner as that of Example 1 except that the coating material for adhesive layer of Example 1 was changed to the following coating material for adhesive layer.

### <Composition of Coating Material for Adhesive Layer>

| | | |
|---|---|---|
| Ionizing radiation curable resin | 52.5 | parts |
| (solid content: 100%, NK Oligo U-200PA, | | |
| Shin-Nakamura Chemical Co., Ltd.) | | |
| 2-Hydroxyethyl methacrylate | 40 | parts |
| Butyl acrylate | 7.5 | parts |
| Photopolymerization initiator | 5 | parts |
| (Irgacure 184, Ciba Japan K.K.) | | |

### Comparative Example 2

A laminate F of Comparative Example 2 was produced in the same manner as that of Example 1 except that the coating material for adhesive layer of Example 1 was changed to the following coating material for adhesive layer.

### <Composition of Coating Material for Adhesive Layer>

| | |
|---|---|
| Ionizing radiation curable resin | 100 parts |
| (solid content: 100%, NK Ester A-TMM-3N, | |
| Shin-Nakamura Chemical Co., Ltd.) | |
| Photopolymerization initiator | 5 parts |
| (Irgacure 184, Ciba Japan K.K.) | |

### Comparative Example 3

On one surface of a plastic film having a thickness of 50 μm (COSMOSHINE A4300, Toyobo Co., Ltd.), the following hard coat coating material was applied by bar coating, dried, and then irradiated with ultraviolet radiation by using a high pressure mercury vapor lamp (exposure dose: 300 mJ/cm²) to form a hard coat film of Comparative Example 3 having a thickness of 6 μm and thereby produce a plastic film c having a hard coat layer.

### <Composition of Hard Coat Coating Material>

| | | |
|---|---|---|
| Ionizing radiation curable resin composition | 20 | parts |
| (solid content: 80%, UNIDIC 17-806, | | |
| DIC Corporation) | | |
| Dilution solvent | 34 | parts |
| Photopolymerization initiator | 0.8 | part |
| (Irgacure 184, Ciba Japan K.K.) | | |

On the surface of the plastic film c having the hard coat layer on the side opposite to the hard coat layer side, a coating material for adhesive layer having the following composition was applied in a thickness of 30 μm, and dried to form an adhesive layer (before curing). Then, a plastic film having a thickness of 188 μm (COSMOSHINE A4300, Toyobo Co., Ltd.) as an adherend was faced and adhered to the adhesive layer, and they were irradiated with ultraviolet radiation by using a high pressure mercury vapor lamp (exposure dose: 500 mJ/cm²) to completely cure the adhesive layer and thereby produce a laminate G of Comparative Example 3.

### <Composition of Coating Material for Adhesive Layer>

| | |
|---|---|
| Ionizing radiation curable resin | 20 parts |
| (solid content: 80%, U-6HA, | |
| Shin-Nakamura Chemical Co., Ltd.) | |
| Dilution solvent | 20 parts |
| Photopolymerization initiator | 5 parts |
| (Irgacure 184, Ciba Japan K.K.) | |

### Comparative Example 4

A laminate H of Comparative Example 4 was produced in the same manner as that of Comparative Example 3 except that the plastic film of Comparative Example 3 having a thickness of 50 μm (COSMOSHINE A4300, Toyobo Co., Ltd.) was changed to a plastic film having a thickness of 75 μm (COSMOSHINE A4300, Toyobo Co., Ltd.).

### Comparative Example 5

A laminate I of Comparative Example 5 was produced in the same manner as that of Comparative Example 3 except that the plastic film of Comparative Example 3 having a thickness of 50 μm (COSMOSHINE A4300, Toyobo Co., Ltd.) was changed to a plastic film having a thickness of 250 μm (COSMOSHINE A4300, Toyobo Co., Ltd.).

The obtained laminates of Examples 1 to 4 and Comparative Examples 1 to 5 were evaluated for the following items.

### [Measurement of Martens Hardness]

On a transparent polyester film having a thickness of 188 μm (COSMOSHINE A4300, Toyobo Co., Ltd.), each of the coating solutions for adhesive layer of Examples 1 to 4 and Comparative Examples 1 to 5 was applied in a thickness of 30 μm, and dried to form an adhesive layer (before curing). A mold releasing film was adhered to the adhesive layer, and they were subjected to ultraviolet irradiation to cure the adhesive layer. Then, 24 hours after the ultraviolet irradiation, the mold releasing film was delaminated from the adhesive layer. The adhesive layer from which the mold releasing film was delaminated is an adhesive layer “after completion of curing”. Then, Martens hardness of the surface of the adhesive layer after curing was measured by the method defined in ISO-14577-1 (Table 1, “Martens hardness of adhesive layer”). The measurement was performed with a super-microhardness tester (trade name: Fischer Scope HM2000, Fischer Instruments Corporation) in an atmosphere of a temperature of 20° C. and a relative humidity of 60%. The maximum test load was 1 mN. The results are shown in Table 1.

Further, Martens hardness of the surfaces of the hard coat layers of the laminate A to I of Examples 1 to 4 and Comparative Examples 1 to 5, and the hard coat layers of the plastic films a to c having a hard coat layer was measured in the same manner as that of the measurement of the Martens hardness of the surfaces of the adhesive layers after curing described above (hardness of the former corresponds to “Martens hardness of hard coat layer of laminate” in Table 1, and hardness of the latter corresponds to “Martens hardness of film having hard coat layer” in Table 1). The results are shown in Table 1.

[Evaluation based on Martens Hardness]

When the Martens hardness of the hard coat layer of the laminate was lower than 92% of the Martens hardness of the plastic film having a hard coat layer, the result was indicated with the symbol “X”, when not lower than 92% and lower than 96%, the result was indicated with the symbol “◯”, and when not lower than 96%, the result was indicated with the symbol “⊚”. The results are shown in Table 1.

### [Evaluation Based on Pencil Hardness]

Pencil hardness of the surfaces of the hard coat layers of the laminate A to I of Examples 1 to 4 and Comparative Examples 1 to 5 and the hard coat layers of the plastic films a to c having a hard coat layer was measured according to JIS K5600-5-4:1999. When the pencil hardness of the hard coat layer of the laminate decreased to become lower than the pencil hardness of the plastic film having a hard coat layer, the result was indicated with the symbol “X”, and when the pencil hardness of the hard coat layer of the laminate did not decrease, the result was indicated with the symbol “◯”. The results are shown in Table 1.

### [Suitability for Die Cutting (Punching)]

The laminates A to I of Examples 1 to 4 and Comparative Examples 1 to 5 were subjected to die cutting using a die cutting machine to prepare 5 pieces of samples for each laminate. The die cutting was performed for the laminate A to I left for 24 hours after the ultraviolet irradiation of the adhesive layers before curing. When separation or delamination was generated in all of the 5 sample pieces at the time of die cutting, the result was indicated with the symbol “X”, when separation or delamination was generated in 1 to 4 sample pieces among the 5 sample pieces, the result was indicated with the symbol “Δ”, and when separation or delamination was not generated in all of the 5 sample pieces, the result was indicated with the symbol “◯”. The results are shown in Table 1.

TABLE 1

| | | Martens | | | | |
|---|---|---|---|---|---|---|
| | Martens | hardness | | | | |
| | hardness | of film | | | | |
| | of hard | having | Martens | Evaluation | Evaluation | |
| | coat | hard | hardness of | based on | based on | Suitability |
| | layer of | coat | adhesive | Martens | pencil | for die |
| | laminate | layer | layer | hardness | hardness | cutting |
| Example 1 | 222 | 229 | 259 | ⊚ | ◯ | ◯ |
| Example 2 | 218 | 229 | 60 | ◯ | ◯ | ◯ |
| Example 3 | 196 | 203 | 259 | ⊚ | ◯ | ◯ |
| Example 4 | 195 | 203 | 62 | ⊚ | ◯ | ◯ |
| Comparative | 205 | 229 | 8 | X | X | ◯ |
| Example 1 | | | | | | |
| Comparative | 225 | 229 | 397 | ⊚ | ◯ | X |
| Example 2 | | | | | | |
| Comparative | 436 | 450 | 287 | ⊚ | ◯ | Δ |
| Example 3 | | | | | | |
| Comparative | 421 | 450 | 287 | ◯ | ◯ | Δ |
| Example 4 | | | | | | |
| Comparative | 479 | 450 | 287 | ⊚ | ◯ | Δ |

It can be understood as follows from the results shown in Table 1.

In the laminates of Examples 1 to 4, the Martens hardness values of the adhesive layers were higher than 25% of the Martens hardness values of the hard coat layers of the films having a hard coat layer, and therefore decrease of the surface hardness of the hard coat layers of these laminates could be prevented without being influenced by the adhesive layers. Further, since the Martens hardness values of the adhesive layers were lower than 260 N/mm², they showed good suitability for die cutting and flatness.

In particular, in the laminates of Examples 1, 3 and 4, the Martens hardness values of the adhesive layers were higher than 30% of the Martens hardness of the hard coat layers of the films having a hard coat layer, and therefore they were not influenced by the adhesive layer, and showed good evaluation results not only in the evaluation based on pencil hardness, but also in the evaluation based on the Martens hardness.

In the laminate of Comparative Example 1, the Martens hardness of the adhesive layer was lower than 25% of the Martens hardness of the hard coat layer of the film having a hard coat layer, the laminate of Comparative Example 1 was influenced by the adhesive layer, and could not prevent decrease of the surface hardness of the hard coat layer of the laminate.

In the laminate of Comparative Example 2, the Martens hardness of the adhesive layer was not lower than 25% of the Martens hardness of the hard coat layer of the film having a hard coat layer, but the Martens hardness of the adhesive layer was higher than 260 N/mm². Therefore, it had a problem concerning suitability for die cutting.

In addition, from the results of Comparative Examples 3 to 5, it was found that neither the Martens hardness of the plastic film c having a hard coat layer, nor the Martens hardness of the hard coat layers of the laminates G to I were influenced by thickness of the substrates.

### Example 5

A laminate A1 of Example 5 was produced in the same manner as that of Example 1 except that the ultraviolet irradiation dose used for the laminate A of Example 1 was changed to 100 mJ/cm² so that the adhesive layer was half-cured. The evaluation of suitability for die cutting was performed for the laminate A1 in which the adhesive layer was in a half-cured state in the same manner as described above, and a result similar to that of Example 1 was obtained.

Then, the laminate A1 in which the adhesive layer was in a half-cured state was subjected to die cutting using a die cutting machine in the same manner as described above, and further irradiated with ultraviolet radiation by using a high pressure mercury vapor lamp (exposure dose: 400 mJ/cm²) to completely cure the adhesive layer. When this laminate A1 in which the adhesive layer was completely cured was similarly evaluated for the aforementioned items (except for the suitability for die cutting), superior results were obtained as in Example 1.

From the above results, it could be confirmed that if the Martens hardness of the adhesive layer was adjusted to be a predetermined value, good evaluation results could be obtained for pencil hardness and suitability for die cutting, even if the adhesive layer was in a half-cured state.

1. A functional film comprising a plastic film having a functional layer constituted by a cured film on one surface and an adhesive layer before completion of curing on the other surface, wherein:
the adhesive layer contains a curable adhesive that can be cured by irradiation of ionizing radiation or heating, and
the adhesive layer is constituted so that the adhesive layer after being cured by irradiation of ionizing radiation or heating shows a Martens hardness of 260 N/mm² or lower, and the following relational expression is satisfied:
Martens hardness of the adhesive layer after curing≧Martens hardness of the functional layer×0.25.

2. A laminate comprising a plastic film having a functional layer constituted by a cured film on one surface and an adherend adhered to the plastic film via an adhesive layer before completion of curing, wherein:
the adhesive layer contains a curable adhesive that can be cured by irradiation of ionizing radiation or heating, and
the adhesive layer is constituted so that the adhesive layer after being cured by irradiation of ionizing radiation or heating shows a Martens hardness of 260 N/mm² or lower, and the following relational expression is satisfied:
Martens hardness of the adhesive layer after curing≧Martens hardness of the functional layer×0.25.

3. A laminate comprising a plastic film having a functional layer constituted by a cured film on one surface, an adhesive layer after completion of curing and an adherend laminated on the plastic film in this order, wherein:
the adhesive layer contains a curable adhesive that can be cured by irradiation of ionizing radiation or heating, and
the adhesive layer is constituted so that the adhesive layer after being cured by irradiation of ionizing radiation or heating shows a Martens hardness of 260 N/mm² or lower, and the following relational expression is satisfied:
Martens hardness of the adhesive layer after curing≧Martens hardness of the functional layer×0.25.
